(19) United States
(12) Patent Application Publication
(10) Pub. No.: US 2018/0068236 A1
(43) Pub. Date: Mar. 8, 2018

(54) SYSTEM AND METHOD FOR HOTEL MARKETING AND MANAGING INVENTORY

(71) Applicants: Amar Lalvani, New York, NY (US); Jimmy Suk Suh, Cliffside Park, NJ (US)

(72) Inventors: Amar Lalvani, New York, NY (US); Jimmy Suk Suh, Cliffside Park, NJ (US)

(21) Appl. No.: 15/698,428

(22) Filed: Sep. 7, 2017

Related U.S. Application Data
(60) Provisional application No. 62/385,130, filed on Sep. 8, 2016.

(51) Int. Cl. G06Q 10/02; G06Q 50/12; G06Q 30/06

(52) U.S. Cl. CPC G06Q 10/02; G06Q 30/0639; G06Q 30/0643; G06Q 50/12

(57) ABSTRACT

A method for marketing and selling unused hotel inventory to a user via a mobile digital device having a display screen comprising the steps of displaying a curated list of hotels having one or more rooms available on a first day during a booking window that opens on the first day, receiving from the user a selection of one of the hotels on the curated list during the booking window, displaying a booking link to the user, receiving a booking request via the booking link, and booking a reservation for a room at the selected hotel.

### BACKGROUND OF THE INVENTION

### Field of the Invention

The invention relates generally to the field of marketing hotel rooms, and managing and selling inventory of hotel rooms. The invention relates specifically to systems and methods for marketing and selling unused hotel room inventory on arrival day.

### Background

Despite the development of new technologies and methods for marketing hotel rooms, many hotel rooms go vacant despite actual demand for such rooms. Online and applications based marketing and reservation systems still fail to effectively sell inventory available on the day of stay. The present invention is a system and method for marketing and selling unused hotel inventory the day it is available.

### SUMMARY OF THE INVENTION

A method for marketing and selling unused hotel inventory to a user via a mobile digital device having a display screen comprising the steps of displaying a curated list of hotels having one or more rooms available on a first day during a booking window that opens on the first day, receiving from the user a selection of one of the hotels on the curated list during the booking window, displaying a booking link to the user, receiving a booking request via the booking link, and booking a reservation for a room at the selected hotel.

### BRIEF DESCRIPTION OF THE DRAWINGS

FIG. 1 is an exemplary embodiment of a system screen as disclosed herein.

FIG. 2 is an exemplary embodiment of a system screen as disclosed herein.

FIG. 3 is an exemplary embodiment of a system screen as disclosed herein.

FIG. 4 is an exemplary embodiment of a system screen as disclosed herein.

FIG. 5 is an exemplary embodiment of a system screen as disclosed herein.

FIG. 6 is an exemplary embodiment of a system screen as disclosed herein.

FIG. 7 is an exemplary embodiment of a system screen as disclosed herein.

FIG. 8 is an exemplary embodiment of a system screen as disclosed herein.

FIG. 9 an an exemplary embodiment of a system screen as disclosed herein.

### DETAILED DESCRIPTION

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

In various embodiments, the present invention comprises a networked system and methods for managing hotel room inventory and marketing hotel rooms available on the day of arrival. The networked system and methods provide for marketing and booking hotel inventory available on the day of stay, but only after a particular time of day such that the hotel inventory is available only during a limited booking window. The available booking window may vary and encompass different ranges of opening and closing times between 1 p.m. local hotel time on the night of the stay and 8 a.m. the following morning. In one embodiment of such a system and method, available hotel inventory would be available for booking during a booking window opening at 3 p.m. local hotel time and closing at 5 a.m. (for the previous day) the following morning.

In various exemplary embodiments, the list of hotels participating in the networked system and methods is limited to a relatively small group of hotels specially selected for participation. Such hotels may be selected for a particular set of marketing characteristics, location, amenities, etc. For example, such a curated list of hotels could be limited to boutique hotels or hotels in particular neighborhoods. In one exemplary embodiment the curated list of available hotels in a particular city may be limited to a select number of hotel properties.

The following overview of the networked system is exemplary only and it will be readily understood that the present invention can be implemented through a variety of different centralized or distributed system architectures. The networked system and methods may include backend systems with equipment including without limitation one or more servers, digital storage systems, and other hardware as well as software to manage all processing, communications, database, and other functions. The networked system and methods may also include one or more mobile digital devices such as smartphones or tablets. A mobile or web-based application program may provide a system for use on the mobile digital device.

In various exemplary embodiments, the networked system may be managed through a backend system comprising one or more networked backend servers and including various databases for storage of user information, system information, etc. The backend system may receive or may be used to enter and manage information regarding participating hotels, and available hotel rooms from participating hotels, management companies, or any other suitable source for storage, distribution, and use through the network. The backend system may also be used to receive or enter information relating to users of the system, including information regarding credit card or other payment options, loyalty programs, room and hotel preferences, etc. for storage, distribution, and use through the network.

Users' mobile digital devices may communicate with the backend system through wired or wireless connections using any suitable network or protocol, including without limitation the internet. Users' mobile digital devices may include an integrated onboard computer system comprising a display screen, one or more processors, data storage, and communications components to provide digital storage, processing, and communications, and/or one or more media input/output devices such as display screens, cameras, microphones, keyboards, touchscreens, headsets, and/or audio speakers. All communications between and among such components may be multichannel, multi-directional, and wireless or wired, using any appropriate protocol or technology. Users' mobile digital devices may communicate with the backend system through wired or wireless connections using any suitable network or protocol. In various exemplary embodiments, the system may run on the mobile digital devices through a local program or application using the local operating system such as an Android or iOS application, via a browser based system, or using any other suitable system. In various exemplary embodiments, users can log in and/or access the system and account information via any appropriate communication technology including without limitation NFC, Bluetooth, WAN, etc.

In various exemplary embodiments, the system and method may be presented on the display screen of the mobile digital device to allow the user to easily identify and evaluate available hotel room inventory, room rates, and associated information about the available hotel properties, amenities, and activities. The system may present multiple types of information overlaid such that different types of information can be selected or deselected easily by the user. The system may present a variety of screens to the user, which the user can move among using simple inputs such as screen touches, taps, presses, and swipes.

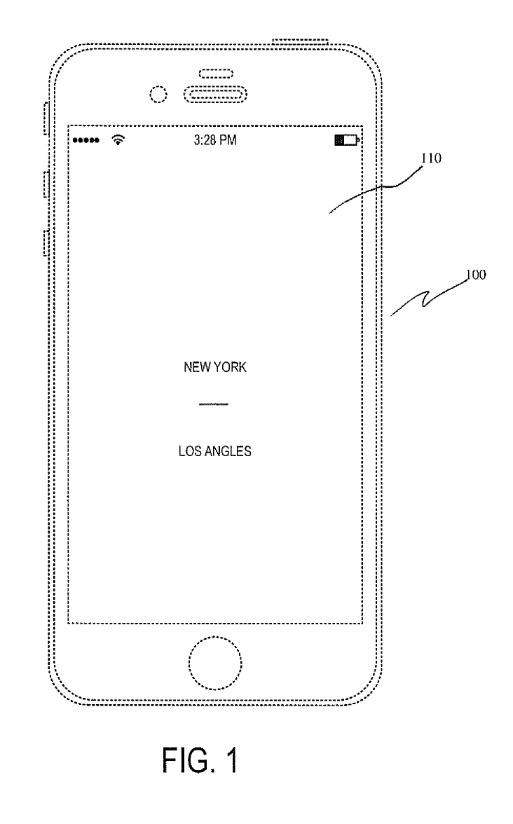

Referring to FIG. 1, in various exemplary embodiments a mobile digital device 100 having a display may be used. The system may provide a home screen 110 that presents basic information about the system and available options such as a choice of cities or other geographical regions where hotel rooms may be available. The user can then select a city or other geographical region using any appropriate input such as a touch, tap, press or swipe.

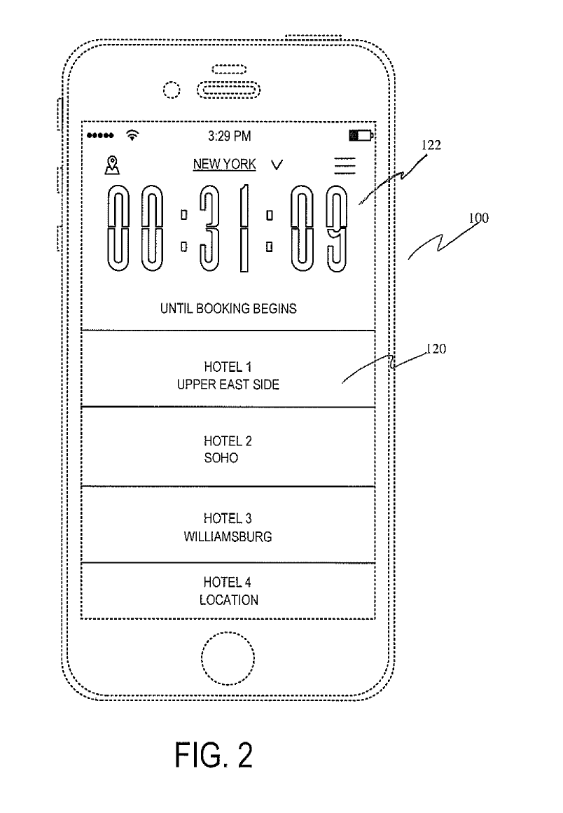

In various exemplary embodiments, selecting a city or other geographical region will display a new screen that identifies the various hotel properties available in that city or other geographical region. Referring to FIG. 2, the system may display a curated list 120 of the names of currently available hotel properties and their rates for the day. The system may also display information regarding the booking window 122, such as whether the booking window is currently open or closed, or when the booking window will be open or closed. The various hotel properties may be identified by name, a photograph, a logo, or any other suitable text or graphical display.

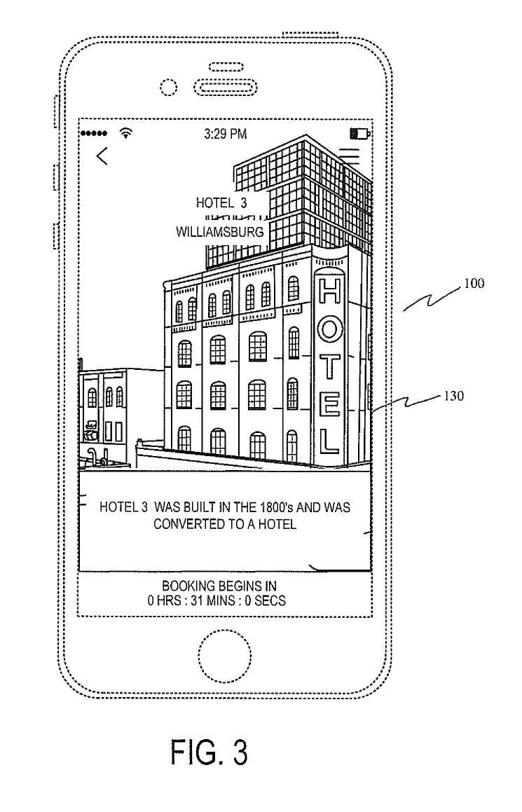

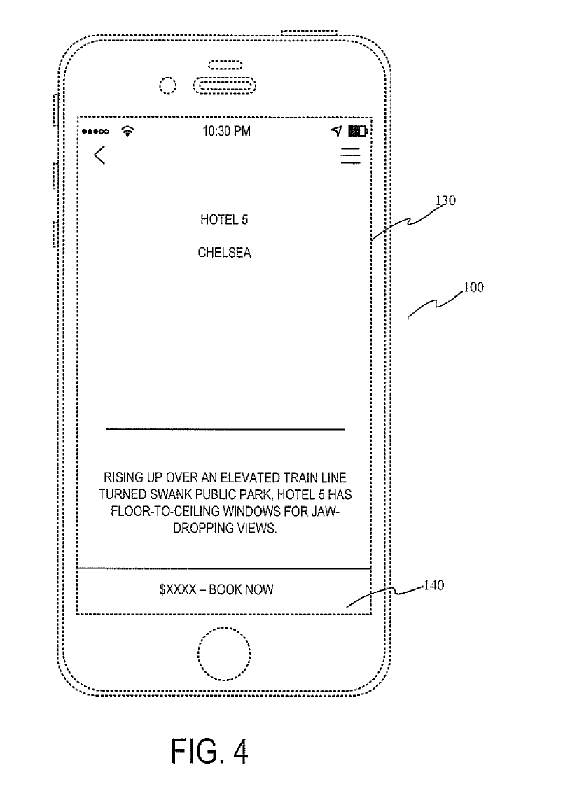

Selecting a property such as by touching or swiping may display additional information about that property. Referring to FIGS. 3 and 4, when a user selects a particular hotel property, the system may present an information screen 130 including one or more photographs, text, videos, or other information about the selected property. Such information may also include information about the facilities, room rates, room types, and/or amenities, as well as information about the booking window for the selected property, such as when the booking window will be open, whether the booking window is currently open, and/or when the booking window will close. Referring to FIG. 4, such information may also include one or more booking links 140 to allow the user to book a room directly if the booking window is open.

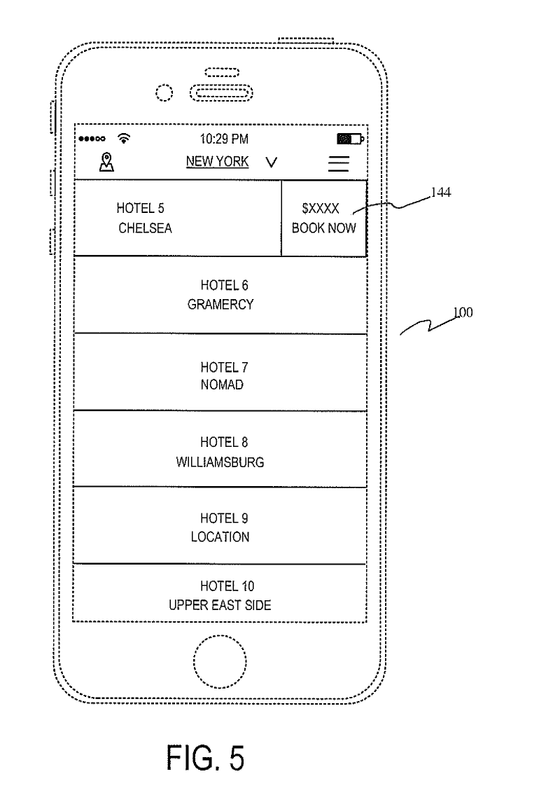

Referring to FIGS. 5 through 7, in various exemplary embodiments the system may provide a simple method for directly booking a room at the available listed hotel properties using the fewest possible number of user interactions. In a preferred embodiment, during the booking window the user can book a room at any available property on the list simply by using a specific interaction for direct booking. For example, the user may be able to directly book a room by fully swiping on the the name of the property to the left. Any suitable interaction may be used to select direct booking. In response to such a selection, the system may complete a booking, or confirm availability subject to final confirmation by the user.

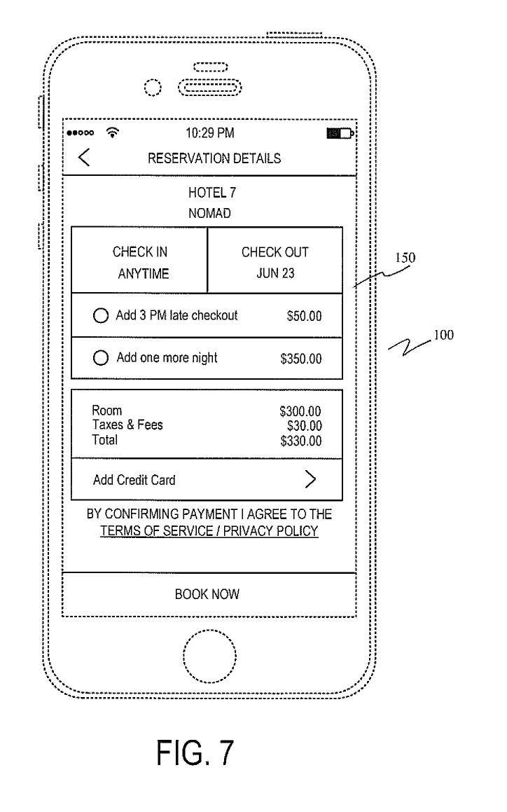

In various exemplary embodiments, the system will then confirm the booking and display reservation details to the user. Referring to FIG. 7, in response to such a selection the system may display a booking details screen 150 presenting details for the booking including check-in and/or check-out times, room rates, taxes and fees, pricing for a late checkout, additional night stay or other available options and amenities that can be added to the reservation. The system may also provide a link to add credit card or other payment information if not already in the system, or to select among available payment options. If final confirmation of the booking is required, the system may also provide a link or other indicator for selection by the user to finally confirm the booking.

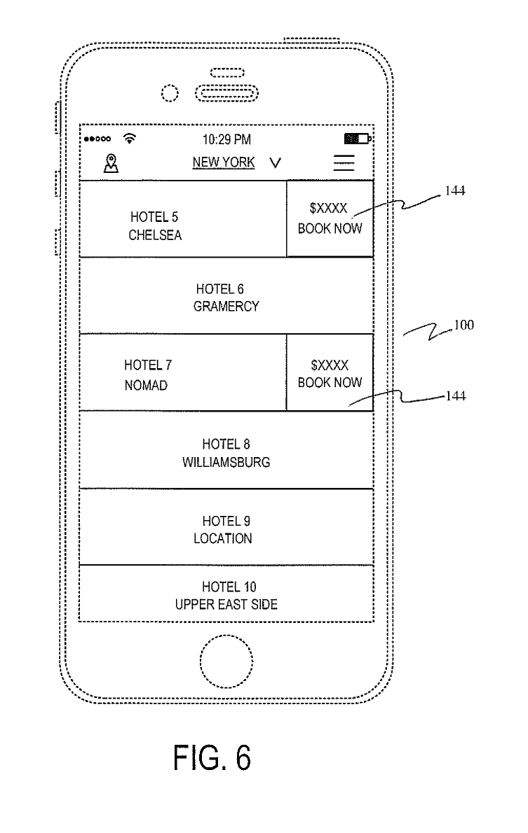

Referring to FIGS. 5 and 6, in various exemplary embodiments the system may provide a simple, easy to use method for comparing available hotel rooms and rates, and booking a selected room. In various exemplary embodiments, the user can reveal the room rates for each hotel property by a specific interaction such as a partial or half-swipe on the identifying information for that hotel property. For example, as shown in FIG. 5, the rate for a room at one property can be revealed in a direct booking link 144 by a partial left-swipe on the name of the hotel. As shown in FIG. 6, rates for one or more hotel properties on the list can be revealed in this way, allowing the user to quickly and easily compare rates for available rooms at multiple properties. While the examples shown in FIGS. 5 and 6 illustrate the resulting display for a partial left-swipe, it will be understood that the partial swipe could be in any suitable direction, or that any other suitable user interaction could be used.

In various exemplary embodiments, the system may allow the user to directly book a room at the selected property by touching the rate displayed by the partial swipe or other interaction. The system may then display a booking confirmation page as described above and shown in FIG. 7, confirming the booking or such that the booking can be confirmed directly by a specific interaction.

In various exemplary embodiments, the system may provide information regarding activities or events available to guests at the listed properties. Such information may be uniquely developed for each available property to reflect the available services and amenities at the property, activities or events provided in connection with partners, and/or may provide links or other ways for the user to reserve participation in such activities or events. In one exemplary embodiment such information may be presented through a set of informational screens arranged by the time of day with information regarding general activities or activities specifically appropriate to that time of day, displayed for the user to plan their activities during their stay. For example, the screen displaying information for morning or for the time of 8 AM may include information about restaurants serving breakfast in or near the hotel property.

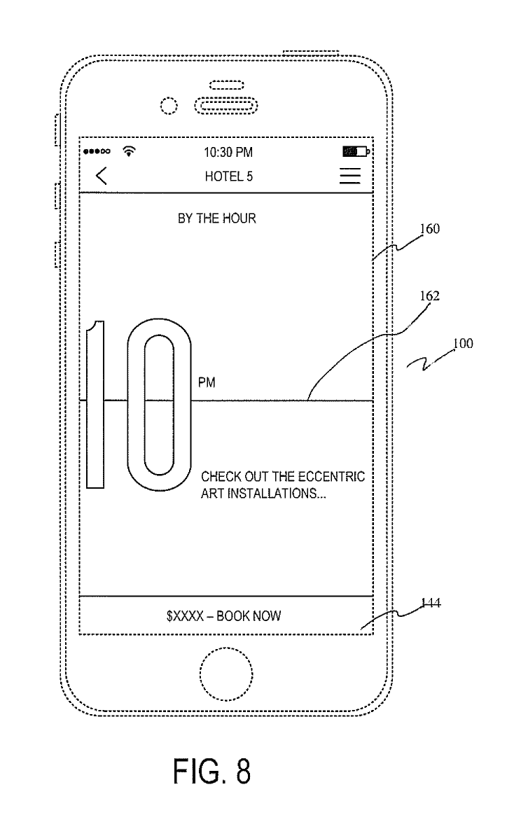

Referring to FIG. 8, in one exemplary embodiment, information arranged by the hour may be presented as a series of flip card screens 160, with a break 162 in the middle of the display area where the display can appear to flip to the next hour. Activities may be shown by the hour, such that the user can touch or swipe up or down to flip to the next earlier or later hour. Such display screens may also include a direct booking link 144 such as described above.

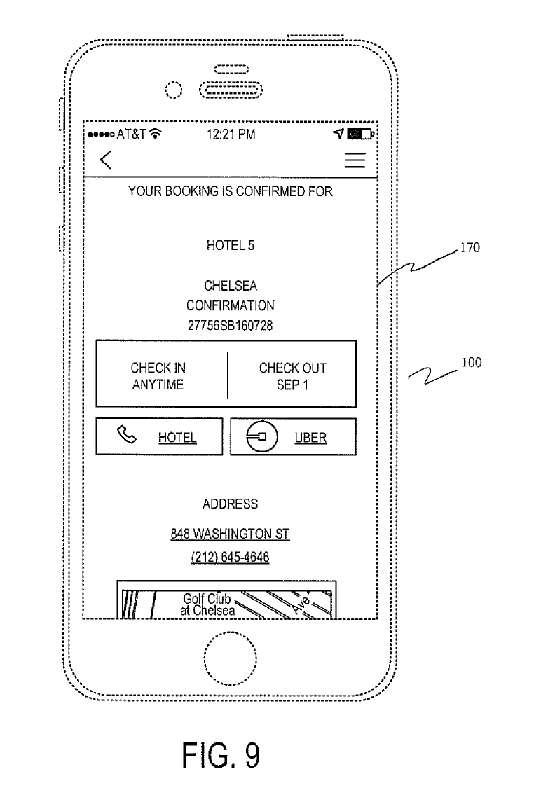

Referring to FIG. 9, in various exemplary embodiments, the system may provide a booking confirmation screen 170 including a confirmation number or other information relevant to the reservation. In various exemplary embodiments, the system may also provide buttons or other indicators to place a telephone call to the hotel or providing a direct link to another mobile application or service.

In various exemplary embodiments, the methods described herein may include the steps of obtaining availability information regarding room availability at certain hotel properties for booking on the current day, receiving and storing such availability information on one or more servers, distributing such availability information via a network to a plurality of mobile digital devices for display to the users of the mobile digital devices, receiving a request for booking from a mobile digital device, determining whether the request was received during a specific booking window, processing the booking request if received during the specific booking window, providing confirmation of the booking to the mobile digital device from which the request was received, wherein the specific booking window is open after a specific time on the day of booking and closes at a specific time on the following day.

In various exemplary embodiments, the methods described herein may include the steps of receiving on a mobile digital device availability information regarding the availability of rooms at a list of hotels for booking the same day during a specific booking window, displaying the availability information on the mobile digital device, displaying information regarding the booking window on the mobile digital device, in response to a specific user input displaying the rate for booking an available room at one or more hotel properties, in response to a different user input displaying details confirming booking of a room at one of the displayed hotel properties.

What is claimed is:

1. A method for marketing and selling unused hotel inventory to a user via a mobile digital device having a display screen comprising the steps of:
displaying a curated list of hotels having one or more rooms available on a first day during a booking window that opens on the first day;
receiving from the user a selection of one of the hotels on the curated list during the booking window;
displaying a booking link to the user;
receiving a booking request via the booking link;
booking a reservation for a room at the selected hotel.

2. The method of claim 1, wherein the booking window opens at 1 p.m. or after on the first day.

3. The method of claim 1, wherein the booking window opens at 3 p.m. or after on the first day.

4. The method of claim 1, wherein the booking window closes the morning of the day after the first day.

5. The method of claim 1, wherein the booking window closes at or before 11 p.m. on the first day.

6. The method of claim 1, wherein the list of hotels includes no more than ten hotels.
